(19) United States
(12) Patent Application Publication
(10) Pub. No.: US 2016/0280331 A1
(43) Pub. Date: Sep. 29, 2016

(54) SNOW VEHICLE SUSPENSION SYSTEM

(71) Applicant: Polaris Industries Inc., Medina, MN (US)

(72) Inventor: Allen Mangum, Ponderay, ID (US)

(21) Appl. No.: 14/683,031

(22) Filed: Apr. 9, 2015

Related U.S. Application Data
(60) Provisional application No. 62/138,136, filed on Mar. 25, 2015.

(51) Int. Cl. B62M 27/02; B60G 13/00; B62D 55/112

(52) U.S. Cl. CPC B62M 27/02; B62D 55/1125; B60G 13/003; B62M 2027/026

(57) ABSTRACT

A snow vehicle suspension is provided for a snow vehicle. The suspension includes a motorcycle frame, and a rear suspension system pivotally coupled with the motorcycle frame, where the rear suspension system supports an endless track. The suspension also includes a suspension strut pivotally coupled at a first end with the motorcycle frame and at a second end pivotally coupled with the rear suspension system, and at least one shock absorber disposed within the endless track.

### CROSS-REFERENCES TO RELATED APPLICATIONS

This application claims the benefit of and claims priority to U.S. Provisional Patent Application No. 62/138,136 entitled “SNOW VEHICLE SUSPENSION SYSTEM” and filed on Mar. 25, 2015 for Allen Mangum, which is incorporated herein by reference.

### TECHNICAL FIELD

The present disclosure relates in general to tracked vehicles and in particular to a tracked vehicle suspension system for a motorcycle.

### BACKGROUND

Tracked vehicles have long been used for travel over snow. Generally, snowmobiles are used for various applications including trail riding, mountain riding, and touring. Additionally, many types of wheeled vehicles have been converted for travel over snow and ice. For example, Ford Model-T automobiles and even older types were long ago converted for use in winter snows by bolting drive tracks and skis where the wheels were originally. More recently, a number of people and companies have offered components, kits, and whole assemblies to convert ordinary motorcycles, ATVs, and other wheeled vehicles for winter use. Some of these are easily reversible, and the skis and drive tracks can be removed and the original wheels reinstalled for summer use.

Regardless of whether the vehicle is a snowmobile or a wheeled vehicle converted to a tracked vehicle, tracked vehicles typically include a drive shaft mounted to a suspension system that supports the endless track. The drive shaft typically includes drive sprockets that engage the endless track. Irregularities in the snow and ice covered terrain cause the suspension system to move. Shock absorbers are typically used to absorb the movement of the suspension system. Common suspension systems are configured to collapse towards the tracked vehicle when absorbing the movement. However, in some situations, the irregularities in the terrain cause movement in the suspension away from the tracked vehicle that is not accommodated by the suspension system.

### SUMMARY

A snow vehicle suspension is provided for a snow vehicle. The suspension includes a motorcycle frame, and a rear suspension system pivotally coupled with the motorcycle frame, where the rear suspension system supports an endless track. The suspension also includes a suspension strut pivotally coupled at a first end with the motorcycle frame and at a second end pivotally coupled with the rear suspension system, and at least one shock absorber disposed within the endless track.

In one embodiment, the suspension strut has a travel distance in the range of between about 1 and 3 inches. In another embodiment, the suspension strut has a travel distance of about 1.5 inches. Additionally, the suspension strut may have a default internal air pressure in the range of between about 200 and 300 psi, and where the internal air pressure is in the range of between about 3000 and 4000 psi in response to an internal piston traveling the travel distance.

In one embodiment, the at least one shock absorber has a travel distance in the range of between about 10 and 20 inches, and a spring rate of about 2500 psi in response to an internal piston traveling the travel distance. In another embodiment, the rear suspension system further also includes track slides, at least a second shock absorber, a front strut, a rear strut, a plurality of upper rollers, and a plurality of lower rollers.

A snow vehicle may also be provided, and in one embodiment includes a primary rear suspension system disposed within an endless track, the primary rear suspension system comprising a plurality of shock absorbers for dampening impact shocks as the rear suspension system travels over snow-covered terrain, and a secondary rear suspension system disposed between a motorcycle frame and the primary rear suspension system

A tracked vehicle suspension is also provided. In one embodiment, the tracked vehicle suspension includes a subframe. The subframe includes a tunnel comprising a plurality of upper rollers for supporting an upper portion of the endless track, a front strut coupling track slides to the tunnel, where each of the track slides comprises a plurality of lower rollers for supporting a lower portion of the endless track, and a front shock absorber coupled with the front strut, and a rear strut coupling the track slides to the tunnel, where the rear strut engages a rear cross shaft disposed between the track slides, and a rear shock absorber coupled with the rear strut. The tracked vehicle suspension also includes a suspension strut pivotally coupling the subframe with a motorcycle frame.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a side view diagram illustrating one embodiment of a track conversion system for a motorcycle in accordance with embodiments of the invention;

FIG. 2 is a side view diagram illustrating one embodiment of the rear track assembly for converting a motorcycle to a snow vehicle in accordance with embodiments of the invention;

FIG. 3 is a side view diagram illustrating a simplified embodiment of the front and rear struts;

FIG. 4 is a perspective view diagram of one embodiment of a motorcycle frame 402 coupled with a subframe 111;

FIG. 5 is a side view diagram illustrating one embodiment of the suspension strut 114 in accordance with embodiments of the invention;

FIG. 6 is a side view diagram illustrating another embodiment of the suspension strut 114 in accordance with embodiments of the present invention; and

FIG. 7 is a perspective view cross-sectional diagram of one embodiment of a suspension strut in accordance with embodiments of the invention.

### DETAILED DESCRIPTION

The subject matter of the present application has been developed in response to the present state of the art, and in particular, in response to the problems and needs in the art that have not yet been fully solved by currently available snow vehicle conversion kits for motorcycles. Accordingly, the subject matter of the present application has been developed to provide a snow suspension system that overcomes at least some shortcomings of the prior art.

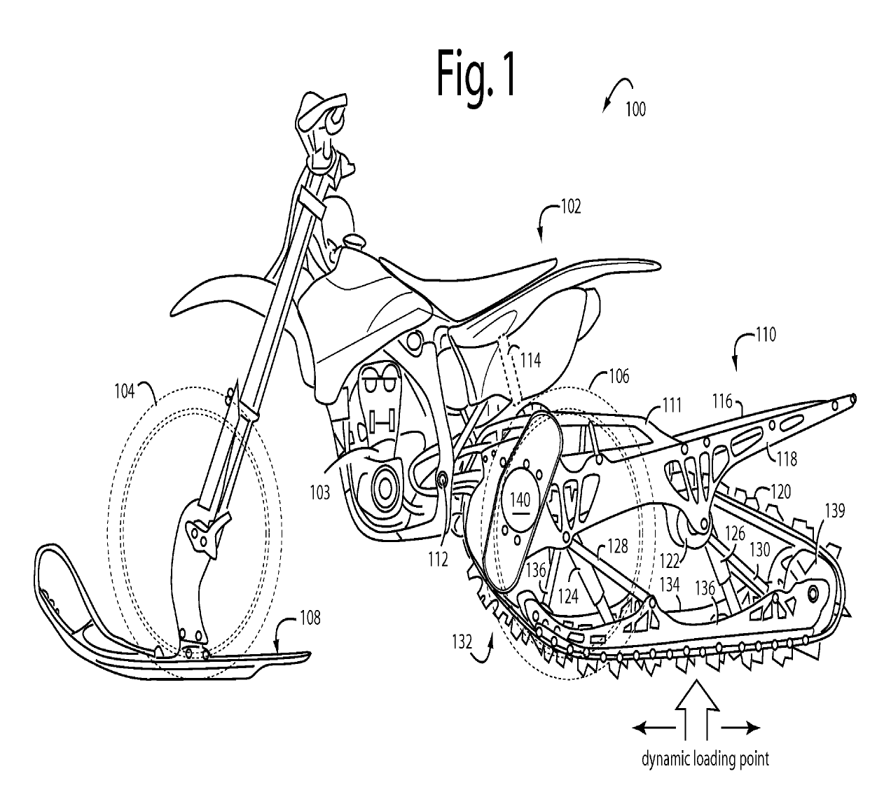

FIG. 1 is a side view diagram illustrating one embodiment of a track conversion system for a motorcycle in accordance with embodiments of the invention. The track conversion system 100 comprises, in one embodiment, a motorcycle 102 with an engine 103 which has had its front wheel 104 and rear wheel 106 and rear swing-arm suspension removed. In one embodiment, a single front steering ski 108 and a rear track drive assembly 110 replace the front wheel 104 and the rear wheel 106, respectively.

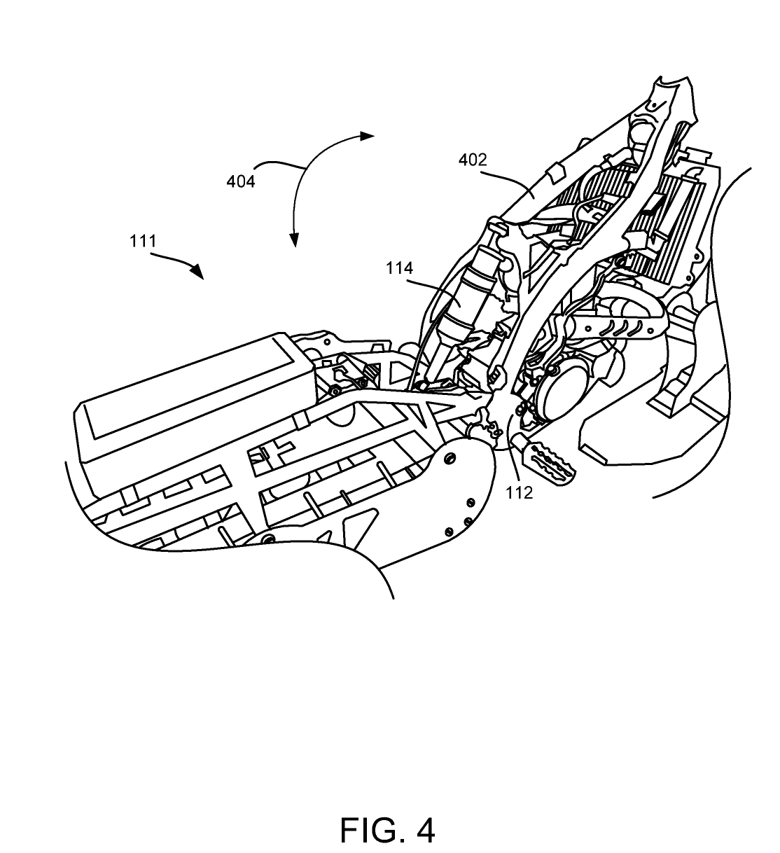

The rear track drive assembly 110, in one embodiment, includes a tubular subframe 111 that attaches to the motorcycle 102 with a rear swing arm pin 112 and a suspension strut 114 that replaces the original motorcycle shock. The suspension strut 114 will be discussed in greater detail below with reference to FIGS. 4-6.

The top part of the rear track drive assembly 110 is coupled, in one embodiment, with the frame of the motorcycle via the suspension strut 114 to dampen movement of the subframe 111 with reference to the frame. A tunnel assembly 116 may attach to both sides of the tubular subframe 111 with tunnel side skirts 118 and provide a protective cover for the top of a drive track 120. The tunnel assembly 116 may also provide mounting points for a track roller 122, forward and aft adjustable shocks 124 and 126, and forward and aft track struts 128 and 130. In another embodiment, the tubular framework of the rear track drive assembly 110 provides the mounting points without a tunnel assembly 116.

The forward and aft shocks 124 and 126, and the forward and aft track struts 128 and 130 together support a hyfax slide suspension 132. A hyfax is a sacrificial plastic glide which runs the length of two parallel rear suspension rails 134 and 136 on both sides. Polystyrene and graphite glide materials can be used because they provide very smooth contact surfaces to the track 120 and low operational friction especially when lubricated with snow.

An adjustable limit strap 138 controls the initial upward tilt of the hyfax slide assembly 132 to the ground and snow underneath. The limiter strap 138 may include adjustment holes in the middle of the strap. Shortening the limiter strap 138 will increase pressure on the front ski 108 and will provide more steering control on steep slopes. Conversely, lengthening the limiter strap 138 will lighten the front ski pressure. Adjusting the limiter strap shifts the center of gravity either forwards or towards the rear, thereby adjusting the center of gravity closer to or farther from the front ski 108. The adjustable limiter strap 138 determines how far away the forward shock 124 can push down the leading edge of the hyfax slide assembly 132. The front leading edge of the hyfax slide suspension 132 is also turned up to provide an approach angle in the range of between about 5 and 30 degrees.

During acceleration and increased loading, the leverage and geometry of the adjustable shock and strut combination is such that the center-point of the track 120, that is supporting the backend weight of snow bike system 100, will dynamically shift further back. The front of the snow bike system 100 will have to take more of the static weight as a result, and the increased static weight will keep the front ski 108 down on the ground and better maintain steering. Such is represented in FIG. 1 by the “dynamic loading point” arrow which can shift forward or back.

A rear track roller 139, in one embodiment, is mounted to the rear end of hyfax slide suspension 132. A jackshaft 140 in a sealed case couples the engine power on a chain and sprocket to a more outboard position where it can power a forward track roller and track drive wheel (covered by tunnel 118 and not shown in FIG. 1) inside the front loop of track 120.

In one embodiment, the length of the rear strut 130 is adjustable. The degree coupling of the back suspension and the amount of lift that will develop on the front ski 108 when climbing a hill can be changed by adjusting the length of rear strut 130. Such adjustment also affects how independent the front and back portions of the hyfax suspension 132 will be from one another, as well as the rear ride height of motorcycle 102.

The geometric relationship of the front and rear adjustable shocks 124 and 126 with their associated front and rear struts 128 and 130 balances the pressures applied to the snow between the front and back halves of the track 120 under the hyfax slide suspension 132. In one embodiment, about 13″ of vertical travel is achieved.

The system 100, as depicted, includes a drive system jackshaft 140. The jackshaft 140, beneficially, positions the drive to the outside of the tunnel rail 118 and allows the above described width of the track 120. In one embodiment, the snow bike system 100 described is a conversion or add-on kit to modify a previously manufactured motorcycle 102 to allow efficient over the snow and ice travel. The front wheel 104, the rear wheel 106, and the swing arm suspension are removed, in one embodiment, to allow for the conversion of the motorcycle into a snow vehicle. A single steering ski assembly 108 is installed in the place of the front wheel to provide for steering. A rear track drive assembly 132 is installed in the place of the rear wheel and swing arm suspension. The rear track drive assembly 132, in one example, includes track slides 134, 136 and a track 120 coupled to the engine 103 via the chain case 140. The track 120 may be driven between a forward track roller and a rear track roller 139 suspended with and positioned fore and aft of the track slides 134, 136.

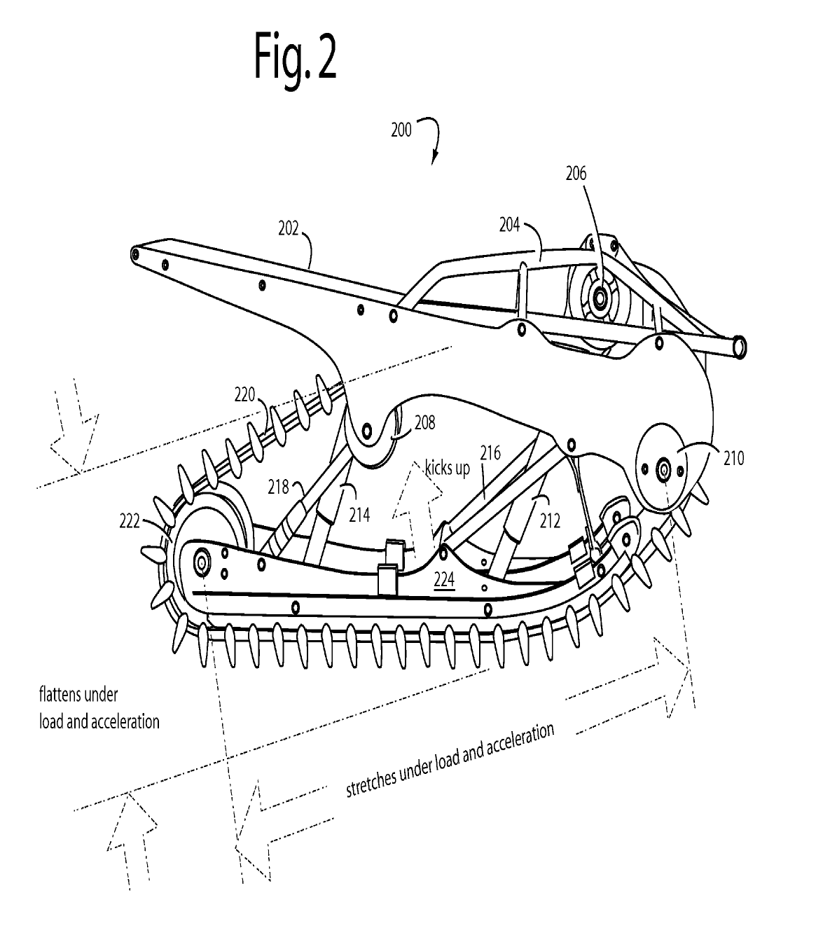

FIG. 2 is a side view diagram illustrating one embodiment of the rear track assembly for converting a motorcycle to a snow vehicle in accordance with embodiments of the invention. As depicted, the rear track assembly 200 includes a suspension system (i.e., shocks and struts) disposed within the track 220. A track tunnel 202 rigidly attached to the underside of a tubular frame 204. Track tunnel 202 has opposite side skirts that provide for the rigid, not-suspended mounting of a jackshaft 206, top track roller 208, a front track roller and drive sprocket 210, front shock 212, rear shock 214, front strut 216, and rear strut 218. As used herein, the terms “front” and “rear” refer to a position on the snow vehicle with reference to the ski. For example, the front shock 212 refers to the shock that is closer to the ski, and the rear shock 214 refers to the shock that is farther away from the ski.

The jackshaft 206 is in a sealed case and is mounted to the track tunnel 202 such that the transmission of power can be carried from the engine 103 (FIG. 1) to a track 220 through the front track roller and drive sprocket 210. Conventional designs do not drive the front track roller and instead include a long transmission and driveshaft mechanisms to drive one of the aft rollers. The jackshaft 206 may include a disc brake and caliper operated by a right-hand handlebar-mounted hydraulic master cylinder on the motorcycle 102.

The suspension system is configured to collapse flat. The separation distance between the front track roller and drive sprocket 210 and a rear belt roller 222 as trail impacts (i.e., changes in terrain) and weight load changes are absorbed. The arcing movement of front strut 216 is especially responsible for this behavior. The suspension system is further configured by the placement of rear strut 218 such that the front of a hyfax slide assembly 224 will be forcefully cantilevered or kicked up relative to the rear belt roller 222 at particular points of the track belt collapse.

The front shock 212 and front strut 216 are strategically disposed in the front half of the suspension system and track drive assembly 200 to control the response of the front portion of the track slide 224 to loads and acceleration. The rear shock 214 and rear strut 218 are disposed in the aft half of the suspension system and track drive assembly 200 to control the response of the rear belt roller 222 and back portion of the track slide 224 to loads and acceleration.

In one embodiment, a back arm slide mechanism included in the rear strut 218 permits the length of the rear strut to slip between a minimum extension position and a maximum extension position. When the rear strut 218 is in the minimum extension position, the front portion of track slide 224 is cantilevered up relative to the rear belt roller 222 and back portion of the track slide 224. This, beneficially, increases the angle of attack or approach of the track. The rear strut is configured, in one embodiment, to transition between the minimum extension position and the maximum extension position by inserting shims 219.

The drive system is such that a first drive chain (not shown) is provided from engine 103 (FIG. 1) to the jack shaft 206 inside tunnel 202. The jack shaft 206 transfers engine driving power to the outside left of tunnel 202. A secondary chain (not shown) drives from jack shaft 206 to front track roller and drive sprocket 210 such that the system drives off the front of the track 220. Chain tensioners may be included on both drive chains to accommodate different sprocket gearing options. The secondary chain drive system is sealed inside a chain case. A typical drive system uses O-ring chains, 4140 Chrome-Moly steel axles, CNC machined drive sprockets and bearing cages, and over-sized sealed axle bearings.

In one embodiment, the front suspension assembly (the front shock 212 and front strut 216) are configured to operate independently from the rear suspension assembly (the rear shock 214 and rear strut 218). Stated differently, in one embodiment, there is no mechanical coupling between the front and rear suspension assemblies such that movement in one affects or causes movement in the other.

As depicted, both the front strut 216 and the rear strut 218 are disposed between the tunnel (formed by side shrouds 209 and the tubular frame 204) and the slide rails 224. Both the front strut 216 and the rear strut 218 are pivotally connected with the slide rails 224 and the side shrouds or skirts 209.

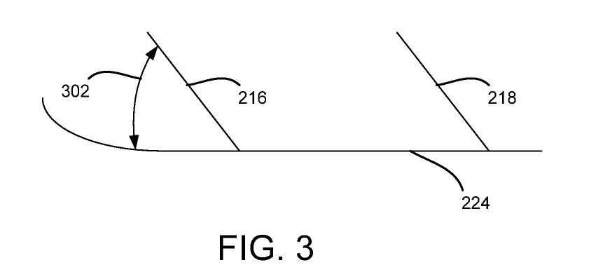

FIG. 3 is a side view diagram illustrating a simplified embodiment of the front and rear struts. As described above, the front strut 216 and the rear strut 218 are configured to collapse towards the slide rail 224 depending on the terrain. In other words, bumps or other irregularities in the terrain encountered by the rear suspension system cause the slide rail to move towards the tunnel. This movement is dampened by the shocks of the front and rear suspension assemblies. Stated differently, the movement is absorbed by the collapsing of the front and rear struts 216, 218 as depicted by arrow 302. The depicted pivoting is along a longitudinal axis of the snow vehicle. The longitudinal axis is an imaginary axis that extends from the front of the snow vehicle to the rear of the snow vehicle through a center of gravity.

FIG. 4 is a perspective view diagram of one embodiment of a motorcycle frame 402 coupled with a subframe 111. As previously described, the subframe 111 may be pivotally connected to the motorcycle frame 402 at the rear swing arm pin 112. The subframe 111 takes the place of the rear swing arm, and the suspension strut 114 takes the place of the traditional motorcycle coil-over shock.

The suspension strut 114 functions as a secondary suspension system to the shocks and struts disposed within the track, as described above. In other words, the suspension strut 114 augments the suspension system within the track by absorbing impact feedback that passes through the subframe 111 to the frame 402. The impact feedback normally would transfer through a solid strut and into the motorcycle frame 402, however, the suspension strut 114 dampens this movement (depicted by arrow 404). Although the above described front and rear struts 216, 218 are generally rigid members, the suspension strut 114 includes some shock absorber components such as, but not limited to, a plunger rod that transfers movement of the subframe 111 into a gas or fluid containing cylinder to dampen the movement by converting the shock energy into heat, for example.

The suspension strut 114, in one embodiment is configured with a substantially higher default (or preload) internal pressure than the front or rear shock of the suspension system disposed within the track. In one embodiment, the suspension strut 114 has an internal preload air pressure in the range of between about 50 and 500 psi. In a further embodiment, the suspension strut 114 has an internal preload air pressure in the range of between about 200 and 300 psi.

The suspension strut 114 is configured, in one embodiment, with a travel distance in the range of between about 1 and 3 inches. As used herein, the term “travel distance” refers to the distance the piston or plunger rod is capable of traveling from an extended position to a collapsed position. In a further embodiment, the maximum travel is 1.5″. At a maximum travel distance of 1.5″, the suspension strut 114 is configured to generate a spring force of between about 3000 and 4000 psi. The suspension strut 114 generates a spring force in a progressive fashion (from the default or preload pressure to the maximum pressure) to provide bottom-out protection. At this pressure, of about 3000 to 4000 psi, the air pressure prevents further suspension strut 114 compression, and thereby prevents the suspension strut 114 from bottoming out. The suspension strut 114 is configured to have an extreme, progressively rising spring rate as compared to a traditional shock absorber.

The travel distance of 1.5″ may be adjustable by adding or removing oil to limit the point where the air pressure “dead heads” the plunger shaft. This is accomplished by replacing air volume with oil volume in an air chamber of the suspensions strut 114. The suspension strut 114 is configured with an initial holding force of 800 lbs. at a default position, and about 4000 lbs. of holding force at the maximum travel distance.

The suspension strut 114 provides a pivoting chassis break between the motorcycle frame 402 and the subframe 111. In other words, the suspension strut 114 assist with weight distribution, ride quality, traction, and over all maneuverability while the primary suspension (i.e., in-track suspension) functions to maintain traction and proper weight distribution through constant motion and reaction to the terrain. This is accomplished with the different characteristics of the suspension strut 114 as compared to the front and rear shock absorbers. For example, in one embodiment, the suspension strut 114 has a maximum travel distance of about 1.5 to 3 inches while the front and rear shock absorbers have maximum travel distances of about 10-20 inches. In another embodiment, the suspension strut 114 may be configured for internal pressures in the range of 50-4000 psi across 1.5 inches of travel, while the front or rear shock absorbers are configured for internal pressures (or spring rates if oil shocks) in the range of 50-2500 psi across 10-20 inches of travel.

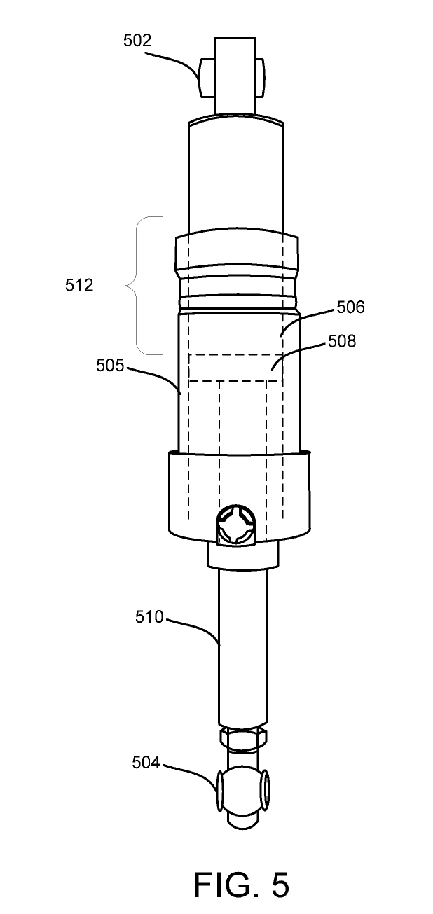

FIG. 5 is a side view diagram illustrating one embodiment of the suspension strut 114 in accordance with embodiments of the invention. The suspension strut, in one embodiment, includes an upper mount point 502 and a lower mount point 504. The upper mount point 502 is configured for pivotally coupling the suspension strut 114 to the motorcycle frame. The upper mount point 502 is configured in a manner similar to an upper mount point of the original motorcycle shock that the suspension strut 114 replaces. Likewise, the lower mount point 504 is configured to pivotally couple with the subframe. Accordingly, the angle of orientation of the suspension strut 114 with reference to the motorcycle frame and the subframe may change as the subframe collapses towards the motorcycle frame.

The suspension strut 114, in one embodiment, includes a shock body 505 enclosing a gas chamber 506. Disposed within the gas chamber 506 is a piston 508 that is coupled with the lower mount point 504 via a piston rod 510. The piston 508, together with valving in the piston 508, is configured to obtain the internal pressures described above with reference to FIG. 4.

The piston 508 is capable of traveling a distance 512 before “dead heading.” Beneficially, the configuration of the suspension strut 114 prevents bottoming out (i.e., the piston 508 coming in contact with the end of the shock housing). The volume of the area above the piston 508 decreases as the piston 508 travels upward. The configuration of the suspension strut 114 is selected to allow for pressures of up to 4000 psi in the area above the piston. Together with any oil in that area, the air “dead heads” the piston 508 and prevents bottoming out. That distance 512 is in the range of between about 1 and 3 inches. In another embodiment, that distance is about 1.5 inches.

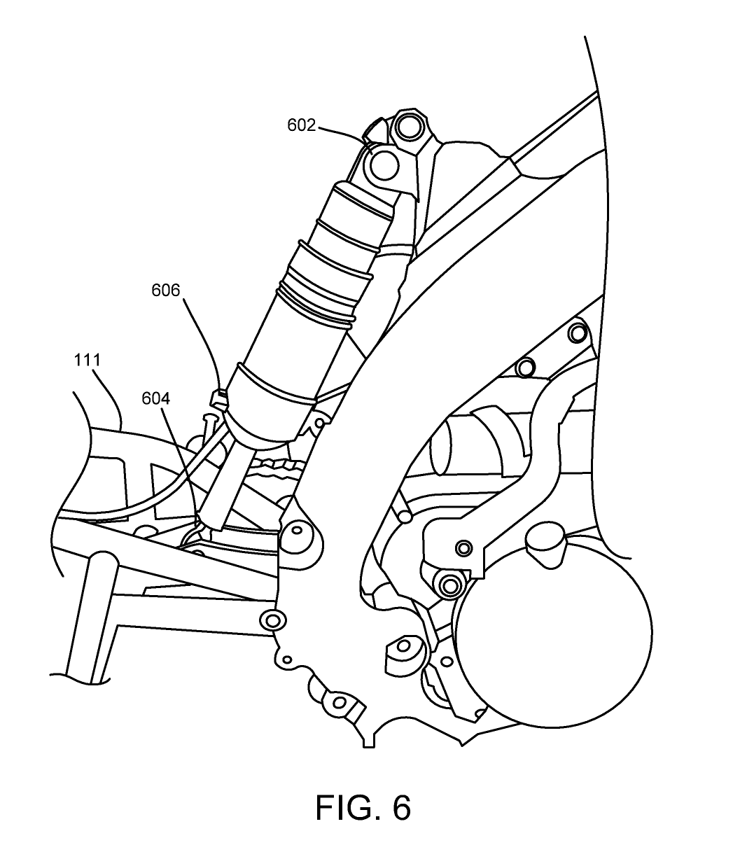

FIG. 6 is a side view diagram illustrating another embodiment of the suspension strut 114 in accordance with embodiments of the present invention. The suspension strut 114, as described above, mounts at the upper end 602 with the motorcycle frame and at the lower end 604 with the subframe. Impact shocks that are transferred into the subframe 111 are dampened by the suspension strut 114.

In one embodiment, the suspension strut 114 includes an adjustment apparatus 606 for adjusting the preload of the suspension strut 114. In one example, the adjustment apparatus 606 is a dial that is turnable. In another embodiment, the adjustment apparatus 606 is a valve for adding or removing air from the suspension strut 114. The height of the motorcycle frame with reference to the subframe may be increased or decreased with via the adjustment apparatus 608.

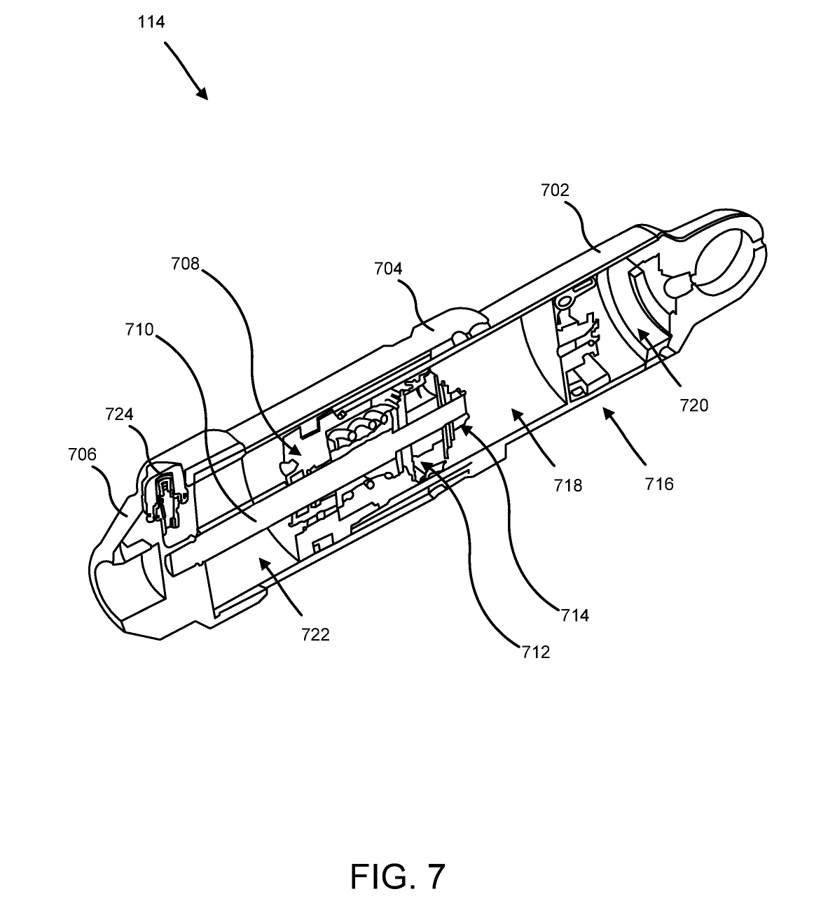

FIG. 7 is a perspective view cross-sectional diagram of one embodiment of a suspension strut 114 in accordance with embodiments of the invention. The suspension strut 114, as described above, is intended to augment the suspension system disposed within the endless track of the vehicle. The suspension strut 114, in one embodiment, includes a body 702 that is slidably disposed within an air body 704.

The air body 704 may be connected by helical threads to a cap assembly 706. A bearing cap 708, or seal head, may be coupled and sealed to an end of the body 702 that is disposed within the air body 704. The bearing cap 708, in one embodiment, is substantially solid to minimize the added air volume from the bearing cap 708. This, beneficially, allows the spring rate (i.e., the air spring rate of the air chamber 722) to ramp quickly. A shock shaft 710 is coupled with the cap assembly 706 and extends through the bearing cap 708.

A piston assembly 712 is threaded onto a second end of the shock shaft 710 by means of a fastener 714. An internal floating piston assembly 716 may be disposed within and movable with relation to the body 702. In one embodiment, the internal floating piston assembly 716 separates an interior area of the body 702 into two chambers. The chambers, in one embodiment, are a damping chamber 718 and a compressible chamber 720.

The suspension strut 114 also includes an air chamber 722. In operation, a compressive force applied to the suspension strut 114 causes the body 702 and the piston assembly 712 to move into the air body 704. As such, the piston assembly 712 also moves which causes a gas in the air chamber 722 to compress and store energy for release during rebound. As described above, the spring rate of the suspension strut 114 is selected to increase rapidly across a short travel distance. This is achieved via the substantially solid bearing cap 708 within an air body 704 having a diameter selected to achieve the desired spring rate. In one embodiment, the air body 704 has a diameter in the range of between about 2 and 6 inches. In another embodiment, the diameter of the air body 704 is in the range of between about 2.5 and 3.5 inches.

Damping occurs as fluid in the damping chamber 718 flows through flow paths (not shown) in the piston assembly 712. As the body 702 moves into the air body 704 during compression, the shock shaft 710 enters the damping chamber 718 and reduces the available fluid volume. In one embodiment, the compressible chamber 720 may be filled with a compressible fluid such as a gas.

In one embodiment, the air chamber 722 may be preloaded at an elevated pressure. Adjusting the preload of the air chamber 722 may function to increase or decrease the overall length of the suspension strut 114, and thereby increasing or decreasing a ride height of the vehicle. Additionally, the preload of the air chamber 722 allows for the vehicle user to adjust the comfort of the suspension to his or her liking. The user may adjust the preload by increasing or reducing the pressure of the compressible fluid via a valve 724 that is fluidly coupled with the air chamber 722. The pressure of the preload is discussed above in greater detail with reference to FIG. 4.

The damping chamber 718 may be filled with a liquid damping fluid that is substantially incompressible. As the suspension shaft 710 enters the damping chamber 718 and reduces the fluid volume, the substantially incompressible damping fluid is displaced and the volume of the damping chamber 718 is increased accordingly. The internal floating piston 716 is configured for transferring pressure from the damping chamber 718 to the compressible chamber 720. In other words, the internal floating piston 716 moves to reduce the volume of the compressible chamber 720 while increasing the volume of the damping chamber 718.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A snow vehicle comprising:
a motorcycle frame;
a rear suspension system pivotally coupled with the motorcycle frame, where the rear suspension system supports an endless track;
a suspension strut pivotally coupled at a first end with the motorcycle frame and at a second end pivotally coupled with the rear suspension system; and
at least one shock absorber disposed within the endless track.

2. The snow vehicle of claim 1, where the suspension strut has a travel distance in the range of between about 1 and 3 inches.

3. The snow vehicle of claim 2, where the suspension strut has a travel distance of about 1.5 inches.

4. The snow vehicle of claim 2, where the suspension strut has a default internal air pressure in the range of between about 200 and 300 psi.

5. The snow vehicle of claim 2, where the internal air pressure is in the range of between about 3000 and 4000 psi in response to an internal piston traveling the travel distance.

6. The snow vehicle of claim 1, where the at least one shock absorber has a travel distance in the range of between about 10 and 20 inches.

7. The snow vehicle of claim 5, where the at least one shock absorber has a spring rate of about 2500 psi in response to an internal piston traveling the travel distance.

8. The snow vehicle of claim 1, where the rear suspension system further comprises:
track slides;
at least a second shock absorber;
a front strut;
a rear strut;
a plurality of upper rollers; and
a plurality of lower rollers.

9. A snow vehicle comprising:
a primary rear suspension system disposed within an endless track, the primary rear suspension system comprising a plurality of shock absorbers for dampening impact shocks as the rear suspension system travels over snow-covered terrain; and
a secondary rear suspension system disposed between a motorcycle frame and the primary rear suspension system.

10. The snow vehicle of claim 9, where the secondary rear suspension system comprises a suspension strut.

11. The snow vehicle of claim 10, where the suspension strut has a travel distance in the range of between about 1 and 3 inches.

12. The snow vehicle of claim 11, where the suspension strut has a travel distance of about 1.5 inches.

13. The snow vehicle of claim 11, where the suspension strut has a default internal air pressure in the range of between about 200 and 300 psi.

14. The snow vehicle of claim 11, where the internal air pressure is in the range of between about 3000 and 4000 psi in response to an internal piston traveling the travel distance.

15. The snow vehicle of claim 9, where the rear suspension system further comprises:
track slides;
a front strut;
a rear strut;
a plurality of upper rollers; and
a plurality of lower rollers.

16. A tracked vehicle suspension comprising:
a subframe comprising:
a tunnel comprising a plurality of upper rollers for supporting an upper portion of the endless track,
a front strut coupling track slides to the tunnel, where each of the track slides comprises a plurality of lower rollers for supporting a lower portion of the endless track, and a front shock absorber coupled with the front strut, and
a rear strut coupling the track slides to the tunnel, where the rear strut engages a rear cross shaft disposed between the track slides, and a rear shock absorber coupled with the rear strut; and
a suspension strut pivotally coupling the subframe with a motorcycle frame.

17. The tracked vehicle suspension of claim 16, where the subframe is pivotally coupled to the motorcycle frame at a swing arm pin.

18. The tracked vehicle suspension of claim 16, where the suspension strut has a travel distance in the range of between about 1 and 3 inches.

19. The tracked vehicle suspension of claim 18, where the suspension strut has a travel distance of about 1.5 inches.

20. The tracked vehicle suspension of claim 19, where the suspension strut has a default internal air pressure in the range of between about 200 and 300 psi.
